(19) United States
(12) Patent Application Publication
(10) Pub. No.: US 2001/0029814 A1
(43) Pub. Date: Oct. 18, 2001

(54) FIBER OPTIC CABLE RIPCORD TOOL AND METHOD OF USE

(76) Inventor: JOSEPH C. TIANO, HICKORY, NC (US)

Correspondence Address: TIMOTHY J ABERLE, PO BOX 489, HICKORY, NC, 286030489

(21) Appl. No.: 09/467,416

(22) Filed: Dec. 20, 1999

(51) Int. Cl. B25B 13/02; B23P 19/00; H01R 43/00

(52) U.S. Cl. 81/119; 29/762; 29/764

(57) ABSTRACT

A ripcord tool for receiving a ripcord of a cable and facilitating the making of a slit in the cable. The tool includes a ripcord section having a ripcord attachment feature for attaching the ripcord to the ripcord section. The tool also includes a torque section operative to transmit torque to the ripcord section, such that rotation of the torque section causes the ripcord section to rotate for wrapping the ripcord about the ripcord section and ripping a component of the cable. A method of using the tool is also disclosed.

The present invention relates to a tool for use with cables, and, more particularly, to a tool for connecting to a ripcord of a cable for ripping at least one component of the cable.

The background of the present invention will be described with reference to exemplary fiber optic cables. Fiber optic cables include optical fibers that transmit voice, video, and computer data information. Fiber optic cables designed for indoor, outdoor, or indoor/outdoor applications may include one or more ripcords and may include one or more binders.

Ripcords are typically used by craftsmen to rip cable components, for example, an armor tape of the cable and/or the cable jacket, whereby the tear facilitates removal of the armor tape and/or cable jacket for accessing buffer tubes and optical fibers in the cable. To avoid breakage of the ripcord during the ripping action, a typical ripcord is preferably made of a high-strength material having a suitable denier. A denier is a unit of weight per length of material for measuring the fineness of threads, yarns, and the like. Binders are tape-like members that are typically used in a fiber optic cable to bind groups of cable components together. For example, one or more binders may be stranded around a cable core prior to the extrusion of a cable jacketing material therearound. Moreover, one or more binders may be used to retain a water swellable tape about a core prior to the cable jacketing operation. Additionally, binders may be stranded about groups of optical fibers to form optical fiber bundles.

When it is desired to gain access to the buffer tubes and optical fibers therein, a craftsman typically must use a cutting tool, e.g., a razor or hook blade, to cut the cable jacket and/or armor tape. Alternatively, the craftsman may use needle-nose pliers to grip and pull the ripcord for the same purpose. The use of a cutting tool or pliers, however, is time consuming, and creates the potential for injury to the craftsman and inadvertent damage to the buffer tubes or other cable components.

The present invention is suitable for use with known fiber optic cables that include at least one ripcord. For example, U.S. Pat. No. 5,642,452 discloses a fiber optic cable with two ripcords. A radially outermost ripcord is located radially inwardly of strength members for ripping the strength members and an outer cable jacket. A radially innermost ripcord is located radially inwardly of an inner jacket for ripping the inner jacket. U.S. Pat. No. 5,621,841 discloses a fiber optic cable having two ripcords. The ripcords are in diametrically opposed locations relative to a center of the cable, and the ripcords are located radially inwardly of a steel tape and an outer sheath. The ripcords are arranged for ripping the armor and possibly the outer sheath as well. U.S. Pat. No. 4,913,515 discloses a fiber optic cable with a glass or aramid fiber ripcord located radially inwardly of optical fibers embedded in a plastic jacket. The ripcord is operative to rip the plastic jacket, and the fiber optic cable may then be unrolled to define an optical fiber ribbon. U.S. Pat. No. 5,268,983 discloses a fiber optic cable with two ripcords. A radially outermost nylon ripcord is located radially inwardly of an outer jacket for ripping the outer jacket. A radially innermost ripcord is part of a core-tube jacket for ripping the core-tube jacket. U.S. Pat. No. 5,029,974 discloses a fiber optic cable with a high-strength ripcord for ripping an armor tape and a cable sheath. U.S. Pat. No. 5,173,961 discloses a fiber optic cable with two ripcords that lie partly within a metallic cable sheath and partly outside of the metallic cable sheath by extending between overlapping edges of the metallic sheath. U.S. Pat. No. 5,321,788 discloses a fiber optic cable that includes a color marker under a tape, and includes two ripcords for facilitating removal of an armor tape and a cable jacket.

### SUMMARY OF THE INVENTION

One aspect of the present invention is a ripcord tool for receiving a ripcord of a cable. The ripcord tool comprises a ripcord section having a ripcord attachment feature for attaching the ripcord to the ripcord section, and a torque section operative to transmit torque to the ripcord section. Rotation of the torque section causes the ripcord section to rotate for wrapping the ripcord about the ripcord section and ripping a component of the cable.

Another aspect of the invention is a method of forming a slit in a cable comprising the steps of: attaching a cable ripcord to the ripcord tool; applying torque to the ripcord tool; and ripping at least one cable component with said ripcord.

### BRIEF DESCRIPTION OF THE DRAWING FIGURES

FIG. 1 is an isometric view of a ripcord tool according to the present invention.

FIG. 2 is an isometric view of the ripcord tool of FIG. 1 being prepared to wrap a ripcord of, for example, a fiber optic cable.

FIG. 3 is an isometric view of the ripcord tool of FIG. 1 during a cable component ripping operation.

FIG. 4 is a cross sectional view of cable components being ripped with a ripcord using the ripcord tool according to the present invention.

### DETAILED DESCRIPTION OF THE INVENTION

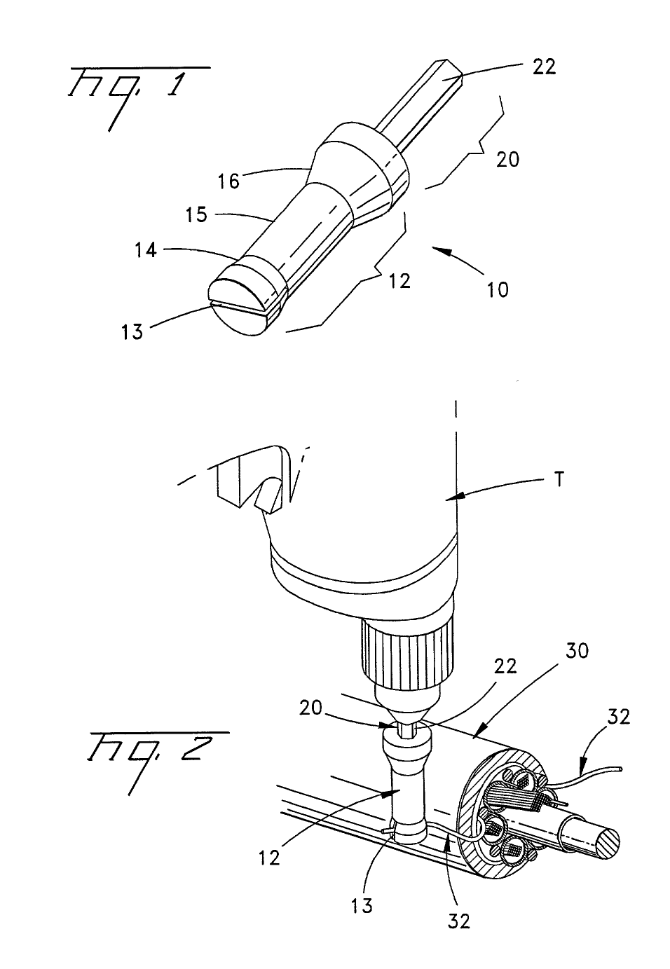

Referring to FIGS. 1-4, an exemplary embodiment of a ripcord tool 10 and a method for using the ripcord tool according to the present invention will be described. The present invention will be described with reference to an exemplary fiber optic cable 30 having at least one ripcord 32 therein. Ripcord 32 is typically a relatively strong aramid material. Where a cable includes two ripcords they are typically located 180° apart relative to the center of fiber optic cable 30. An armor tape 34 and cable jacket 35 surround ripcord 32 (FIG. 4).

Ripcord tool 10 preferably includes at least one ripcord section 12 and at least one torque section 20. Ripcord section 12 includes a ripcord attachment feature, for example, a recess that preferably defines the shape of a slot 13. Slot 13 is sized to releaseably/attachably receive a ripcord therethrough. In addition, ripcord section 12 preferably includes a ramp-like guide 14, a wrap surface 15, and an end section 16. During rotation of tool 10, guide 14 preferably guides the ripcord from slot 13 to wrap surface 15. Wrap surface 15 is preferably generally cylindrical and smooth, but it can be, for example, tapered, contoured, ridged, knurled, and/or grooved to wrappingly receive the ripcord. Additionally, the diameter of wrap surface 15 can be adjusted to accommodate the wrapping of large lengths of ripcord or to adjust for torque requirements. Preferably, guide 14 and end section 16 have respective diameters that are larger than the diameter of wrap surface 15.

Torque section 20 includes a torque member 22 that is preferably mechanically robust enough to transmit forces from a torque generating source to ripcord section 12 for wrapping the ripcord thereabout. Moreover, torque member 22 is preferably shaped to be coupled to a torque generating source in a way that avoids slippage therebetween. For example, torque member 22 can have a polygonal cross section, for example, a hexagonal, square, star shaped, or gear-like profile. Alternatively, torque member 22 can have a circular profile, e.g., a friction roller, or a semicircular profile.

Ripcord tool 10 can be monolithically formed of a metallic material, e.g. aluminum, or a non-metallic material, e.g., a thermoplastic or thermosetting material with suitable mechanical properties. In a preferred embodiment, ripcord section 12 and torque section 20 are separate pieces connected together. The connection can be made by, for example, a set screw, a press-fit connection, a weld, or any other suitable connection means. When the ripcord and torque sections 12,20 are distinct pieces they can be made of the same or different compatible materials. For example, ripcord section 12 can be formed of aluminum and torque section 20 can be formed of steel.

An exemplary working embodiment of tool 10 was made and tested. In the working embodiment: the overall length of tool 10 was 3.25 inches; ripcord section 12 was aluminum and 2 inches in length; torque member 22 was a hexagonal steel shaft 1.75 inches in length; slot 13 was 0.025 inches wide by 0.25 inches deep; guide 14 had a diameter of 0.75 inches; and wrap surface 15 was cylindrical with a 0.5 inch diameter. Torque member 22 was connected to ripcord section 12 by a set screw that was screwed into a tapped hole made in ripcord section 12.

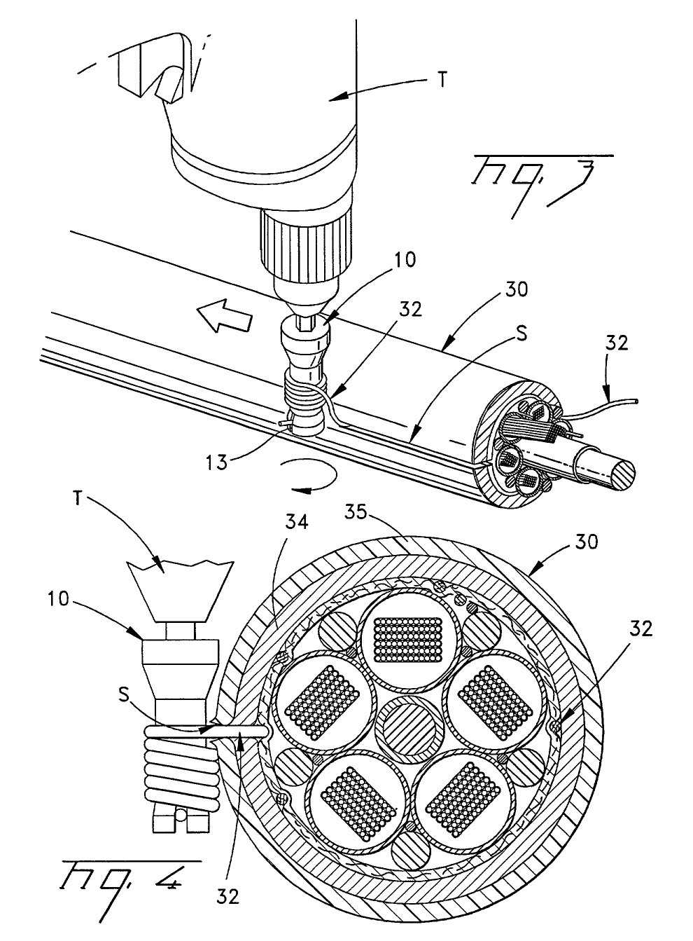

Exemplary operation of tool 10 according to the present invention will now be described. When it is desired to access the buffer tubes and/or optical fibers in fiber optic cable 10, the cable is cut transversely of its longitudinal axis (FIGS. 2-4). Torque section 20 is connected to a torque generating source T, for example, a hand-held power drill or power screw driver. As an illustration, a hex head portion of torque member 22 can be inserted in the complementary shaped clamping jaws of a hand-held drill (FIG. 2). A length of ripcord 32 is attached to ripcord section 12 by insertion of the ripcord through slot 13. Next, the operator will activate the torque source whereby the ripcord will be wrapped about tool 10. The operator and ripping action will move tool 10 longitudinally away from the transverse cable cut as the ripcord is wrapped about tool 10 (FIG. 3). As this occurs, guide 14 guides ripcord 32 to wrap section 15 and the ripcord is wrapped thereabout. End section 16 can reverse the wrap of ripcord 32 so that multiple layers of wrapped ripcord can be supported by wrap section 15. Further, the torque is converted to a pulling force on the ripcord thereby pulling the ripcord through armor tape 34 and cable jacket 35 (FIG. 4). The ripping operation forms a longitudinal slit S in the cable (FIGS. 3-4). The foregoing procedure can be repeated for as many ripcords as the cable contains. For example, if two ripcords are ripped according to the present invention, then cable jacket 35 and armor tape 34 can be peeled away from the cable core. A craftsman need not use a cutting tool to cut binders and/or tape, which saves time and avoids potential injury to the craftsman and inadvertent damage to buffer tubes or other cable components.

The present invention has thus been described with reference to the foregoing embodiments, which embodiments are intended to be illustrative of the inventive concepts rather than limiting. Persons of skill in the art will appreciate that variations and modifications of the foregoing embodiments may be made without departing from the scope of the appended claims. For example, ripcord section 12 may include alternative ways of gripping a ripcord in lieu of or in addition to slot 13, for example, clamps, adhesives, magnets, catches, snagging edges, wedges, fasteners, hooks, and/or springs. In addition, torque source T need not be an electrical device as it can be a hand powered device, e.g., with a T-shaped handle or other gripping structure suitable for use with an operator's hand. In addition, tool 10 can be combined with other tools or tool features, for example, a ratchet driver or a cable stripper as disclosed in U.S. Pat. No. 4,472,877, which is incorporated by reference herein. Furthermore, a series of tools 10 can be operatively connected together through gears and shafts so that a single torque source can be used to power the tools automatically, for example, for ripping opposing sides of a cable at the same time. The present invention is suitable for use with any type of cable having a ripcord or the like, for example, electrical or fiber optic cables.

What is claimed is:

1. A ripcord tool for receiving a ripcord of a cable, said ripcord tool comprising:
a ripcord section, said ripcord section having a ripcord attachment feature for attaching said ripcord to said ripcord section; and
a torque section, said torque section being operative to transmit torque to said ripcord section, whereby rotation of said torque section causes said ripcord section to rotate for wrapping said ripcord about said ripcord section and ripping a component of said cable.

2. The ripcord tool of claim 1, said ripcord attachment feature comprising a slot sized to receive said ripcord.

3. The ripcord tool of claim 1, said ripcord section comprising a wrap surface.

4. The ripcord tool of claim 1, said torque section comprising a polygonal cross sectional shape.

5. The ripcord tool of claim 1, said torque section comprising a cross sectional shape selected from the group consisting of hexagonal, circular, and semi-circular cross sectional shapes.

6. The ripcord tool of claim 1, said ripcord section comprising a guide for guiding said ripcord as it is wrapped about said ripcord tool.

7. The ripcord tool of claim 1, said ripcord section comprising an end section.

8. The ripcord tool of claim 1, said ripcord section comprising a guide and an end section having respective diameters, and a wrap surface having a diameter that is less than at least one of said guide and end section diameters.

9. A method of forming a slit in a cable comprising the steps of:
attaching a cable ripcord to a ripcord tool;
applying torque to the ripcord tool; and
ripping at least one cable component with said ripcord.

10. In the method of claim 9, the step of attaching a cable ripcord to said ripcord tool comprising inserting said cable ripcord into a recess formed in said tool.

11. In the method of claim 9, the step of applying torque to said ripcord tool comprising rotating said ripcord tool with a torque source and wrapping said cable ripcord about a portion of said ripcord tool as said cable component is ripped.
